(19) United States
(12) Patent Application Publication
(10) Pub. No.: US 2010/0031556 A1
(43) Pub. Date: Feb. 11, 2010

(54) DEVICE AND METHOD FOR CONTROLLING INSECT PESTS

(75) Inventors: Kenneth J. Kupfer, Nokomis, FL (US); Robert E. McManus, Nokomis, FL (US)

Correspondence Address: GIFFORD, KRASS, SPRINKLE,ANDERSON & CITKOWSKI, P.C, PO BOX 7021, TROY, MI, 48007-7021, US

(73) Assignee: KM Investors, LLC, Nokomis, FL (US)

(21) Appl. No.: 11/995,631

(22) PCT Filed: Jan. 4, 2008
(86) PCT No.: PCT/US08/50217

§ 371 Date: Jan. 14, 2008

Related U.S. Application Data
(60) Provisional application No. 60/879,060, filed on Jan. 8, 2007.

(51) Int. Cl. A01M 1/20; A01N 25/00

(52) U.S. Cl. 43/131; 424/84; 43/132.1

(57) ABSTRACT

A method and a device for utilizing insects feeding at an insect elimination dispenser as a carrier of a pathogen or like material to eliminate additional insects of the same or different species by providing a contamination band affixed to the dispenser in the path of insects feeding at the dispenser and including a material to contaminate insects contacting the contamination band and the insects, after leaving, contaminate other insects of the same or of a different species.

### CROSS REFERENCE TO RELATED APPLICATIONS

This application claims priority of U.S. Provisional Patent Application Ser. No. 60/879,060 filed Jan. 8, 2007, which is incorporated herein by reference.

### FIELD OF THE INVENTION

The present invention relates to the field of pest control, and moreover, to an insect elimination method and a means for practicing the method wherein the exterior body of an insect is contaminated with a pathogen or similar active ingredient as it feeds at a modified Liquid Gravity Feed Ant Elimination System (LGFAES) or similar dispenser, and the insect, after leaving the dispenser, transfers the active ingredient to other targeted insects.

### BACKGROUND OF THE INVENTION

Applicants of the instant application have previously described a Powdery Formulation for Low-Toxicity Insect Bait in U.S. patent application Ser. No. 11/537,772 filed on Oct. 2, 2006 used in cooperation with the Liquid Gravity Feed Ant Elimination System (LGFAES) dispenser detailed in U.S. Pat. No. 6,467,216 B2, issued Oct. 22, 2002, the entire content of which is now incorporated herein by reference.

### SUMMARY OF THE INVENTION

As demonstrated by the aforementioned patents, Applicants have invented a Liquid Gravity Feed Ant Elimination System (hereinafter “LGFAES”) dispenser and cooperating low-toxicity, liquid bait formulations and methodology in an effort to assist users in the task of attracting and then eliminating ants and many other onerous insect species. With this instant application, however, Applicants address the desirability of providing a method and a device for practicing the method within the LGFAES that increases the effectiveness of the system in causing exponential elimination of insects of the same and/or different insect species.

In addition, with this instant application, Applicants address the desirability of providing the LGFAES dispenser with an insect contamination band or ring-like device that when impregnated or otherwise coated with a fungus or other such active ingredient provides a means for transferring the active ingredient onto the exterior surface of the insect when it is attracted to the dispenser, and then leaves the dispenser to contact and consequently to infect or otherwise fatally affect other insects of the same and/or different insect species.

The provision of the device noted above provides a method in addition to and operating concurrently with the low-toxicity liquid insect bait dispensing of the LGFAES dispenser, with which to utilize insects attracted to, and subsequently leaving the dispenser as a method of transferring an active ingredient such as a fungus or similar species-specific, bio-rational substance which when mating with or otherwise in contact with other insects of the same species is transferred to the insects to contaminate and thereby eliminate same-species insects; or when in contact with other insects of a different species as in the case of the Argentine or similar ants, when these ants are protecting the mealybugs, aphids and other such homoptera to harvest their honeydew, the contaminant is transferred to the different species insect to eliminate those insects.

The fungus or similar pathogen-like active ingredient, impregnated or otherwise applied to the contamination band, is preferably low-toxic, species specific, and the band is easily attached to base of the LGFAES dispenser and replaced when replenishment of the active material is required. The band provides a medium for holding the above-described active ingredients in place adjacent to the feeding pool of the LGFAES dispenser and contaminates the exterior body of the insects as they pass over the contamination band.

In addition, with this instant application, Applicants address the condition wherein the liquid insect bait/attractant used within the LGFAES dispenser is species specific, with the insect targeted being the same as or differing from that targeted with the active ingredient included in the device noted above; and the liquid bait, including or not including an active ingredient, in addition to the insect attractant.

### BRIEF DESCRIPTION OF THE DRAWINGS

A clearer understanding of the present invention can be had upon reference to the following drawing in which:

FIG. 1 is a transverse cross-sectional view of LGFAES dispenser incorporating the contamination band of the present invention;

FIG. 2 is a fragmentary elevational view of the modified LGFAES dispenser shown in FIG. 1; and

FIG. 3 is a cross-sectional view illustrating the layers of material which make up the contamination band.

### DETAILED DESCRIPTION OF A PREFERRED EMBODIMENT OF THE INVENTION

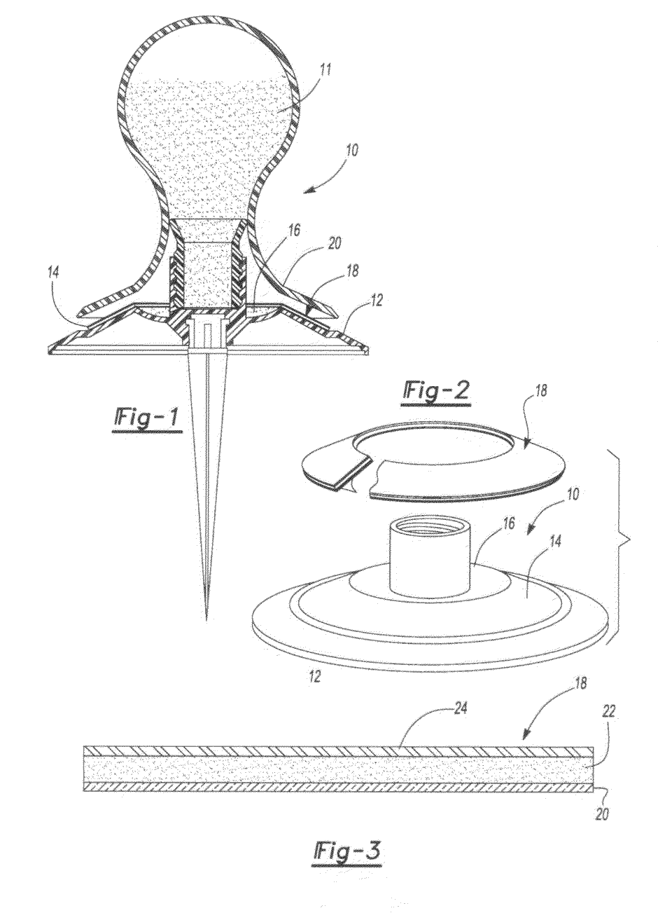

Referring to FIG. 1, there is provided a cross-sectional view of a Liquid Gravity Feed Ant Elimination System (LGFAES) dispenser 10 used for the attraction and elimination of insect pests. As its name comprehends, the LGFAES dispenser 10 includes for its use a liquid low-toxicity bait 11 to lure targeted ants or other insect pests.

As shown in FIGS. 1 and 2, the dispenser 10 includes a base 12 and an outer ring 14 is formed in the base 12 adjacent to a feeding pool 16 to contain bait or attractant 11 for the pest being targeted. A contaminant band 18 of the present invention is mounted to the outer ring 14 adjacent the feeding pool 16 in a position to be protected by an overhanging flanged edge 20 of the dispenser 10.

FIG. 3 illustrates a cross-sectional, three layer view of the band 18 impregnated or coated with a fungus or similar active ingredient, showing a lower adhesive layer 20; a center active ingredient containment layer 22; and an outer protective layer 24.

In one embodiment of the present invention, the insect contamination band 18 noted above consists of the three layers as shown in FIG. 3: the adhesive layer 20 is comprised of a silicone adhesive to allow affixing of the band 18 to the base 12 of the LGFAES dispenser 10; the center containment layer 22 consisting of a copolymer membrane for retention of an active ingredient in the form of a strain of beauvaria bassiana (fungus) prior to its measured release to contaminate insects as they come in contact with the contamination band 18. The protective outer layer 24 preferably comprises a polyester material to contain the fungus within the contaminant band 18 until the band is affixed to the LGFAES dispenser 10, which is then activated by removing and discarding the outer protective layer 24.

In the embodiment of the present invention indicated above, the contaminant band 18 is impregnated or otherwise coated with an active ingredient in the form of a strain of beauvaria bassiana, a low-toxic species-specific fungus, for the contamination the exterior body of the Argentine ant or similar type ant when they are attracted to the dispenser 10, and for the subsequent transfer of the toxin to infect the targeted mealybugs, aphids and other crop-damaging homoptera. This transfer occurs on contact as the ants farm the homoptera to harvest their honeydew.

In another embodiment of the present invention, the contamination band 18 is impregnated or otherwise coated with an active ingredient in the form of the insecticide fipronil, for contaminating the exterior body of the mealybugs, aphids and other homoptera when they are attracted to the dispenser and for the subsequent transfer of said active ingredient to infect or otherwise fatally affect other insects of same species, when mating or incident to other contact.

It should be understood that although a preferred device and method of the present invention has been disclosed, modifications could be made without departing from the spirit of the invention. It is only necessary that adjustment to the active ingredients and the contamination band configuration and the active ingredient/attractant and configuration of the LGFAES dispenser be modified to accommodate the attraction, contamination and transfer to infect different targeted insects.

In addition, it should be understood that although preferred active ingredients of the present invention have been disclosed changes can be made without departing from the spirit of the invention. Other potential active ingredients to impregnate or coat the band device include insect growth regulator, mating disruption pheromone, BT protein, virus or other such bio-rational concoction.

While the foregoing example describes a certain preferred embodiment, it is to be recognized that one of ordinary skill in the art could adopt other forms; accordingly, the scope of the invention is to be limited only by the following claims.

We claim:

1. A method for eliminating ants and other insect pests comprising:
providing a dispenser containing an insect attracting bait for attracting specific insect pests;
providing a band impregnated or coated with an active ingredient attached to and located within said dispenser to intercept and contaminate insect pests attracted to said dispenser;
said active ingredient being species specific, to be carried by the attracted insect pests to infect or otherwise affect other insects of the same species, when mating, feeding or in other contact.

2. The method as recited in claim 1, further comprising:
said active ingredient being a fungus, beauvaria bassiana.

3. The method as recited in claim 1, further comprising:
said active ingredient being fipronil.

4. The method as recited in claim 1, further comprising:
said active ingredient containing fipronil carried by the homoptera attracted to the dispenser to infect the mealybugs, aphids and other such homoptera, when mating and in other contact.

5. The method as recited in claim 1, further comprising:
said insect bait used in said dispenser being a formulation with a species-specific attractant, but not including an active ingredient.

6. The method as recited in claim 1, further comprising:
said liquid insect bait used in said dispenser being a formulation with species-specific attractant, including an active ingredient.

7. A method for eliminating ants and other insect pests comprising:
providing a dispenser for attracting specific insect pests;
providing a band impregnated or coated with a toxin formulation attached to and located within said dispenser to intercept and contaminate insect pests attracted to said dispenser;
said active ingredient being species specific, to be carried by insect pests attracted to said dispenser to infect or otherwise affect other insects of a different species, when in contact.

8. The method as recited in claim 7, further comprising:
said active ingredient comprising a species-specific fungus carried by attracted foraging Argentine ants to infect mealybugs, aphids and other such homoptera that said ants farm and harvest the honeydew of said homoptera.

9. The method as recited in claim 7, further comprising:
said active ingredient being a fungus, beauvaria bassiana.

10. The method as recited in claim 1, further comprising:
said active ingredient being fipronil.

11. A band for attachment to a dispenser said dispenser containing an insect pest attractant, said band comprising an exposed layer of an active ingredient operable to infect and to be attached to insect pests attracted to said dispenser to be carried away from the dispenser to infect other insect pests.

12. The band as defined in claim 11, further comprising:
said active ingredient being a fungus, beauvaria bassiana.

13. The band as defined in claim 11, further comprising:
said active ingredient being fipronil.
